(19) United States
(12) Patent Application Publication
(10) Pub. No.: US 2009/0207942 A1
(43) Pub. Date: Aug. 20, 2009

(54) Embedded Multimedia System and Related Digital Audio Broadcasting Demodulator

(76) Inventors: Tzu-Ping Lin, Taipei Hsien (TW); Cheng-Hsiung Hsu, Taipei Hsien (TW); Wen-Jau Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/253,208

(22) Filed: Oct. 16, 2008

(30) Foreign Application Priority Data
Feb. 19, 2008 (TW) 097105725

(51) Int. Cl. H04L 27/00; G06F 17/00

(52) U.S. Cl. 375/324; 700/94

(57) ABSTRACT

An embedded multimedia system for playing analog and digital audio broadcasting signals includes an antenna for receiving analog and digital audio broadcasting signals, an audio output device for outputting sound, an analog demodulator for demodulating analog audio broadcasting signals for the audio output device, and a digital demodulator for conducting a signal connection between the antenna and the analog demodulator, or transforming digital audio broadcasting signals into analog audio broadcasting signals for the analog demodulator.

### BACKGROUND OF THE INVENTION

1. Field of the Invention

The present invention relates to an embedded multimedia system and related digital audio broadcasting demodulator, and more particularly, to an embedded multimedia system and related digital audio broadcasting demodulator capable of playing analog and digital broadcast programs.

2. Description of the Prior Art

Digital audio broadcasting (DAB) or high definition radio technique is a 3rd-generation broadcasting technique following AM and FM broadcasting. The DAB technology has better spectral utilization efficiency, and can solve the lack of available broadcasting cannels. Moreover, the DAB technology also can provide CD-like quality and additional data service fitting the diversification of broadcasting media. Therefore, the analog broadcasting system tends to be replaced by the digital audio broadcasting system.

Techniques, such as modulation and coding, utilized by the digital audio broadcasting system are greatly different from those utilized by the conventional AM and FM broadcasting systems. Hence, the conventional AM and FM demodulators, such as a radio, cannot be used in the digital audio broadcasting system. In other words, a user needs to buy a digital broadcasting demodulator for receiving digital broadcasting programs. However, for a vehicle multimedia system, the user cannot receive the digital broadcasting programs in a car by replacing a digital broadcasting demodulator, causing inconvenience for the user.

In short, due to a vehicle multimedia system is integrated with a vehicle housing or interior, the user cannot easily replace the broadcasting demodulator, such that the user cannot receive the digital broadcasting programs.

### SUMMARY OF THE INVENTION

It is therefore a primary objective of the claimed invention to provide an embedded multimedia system and related digital audio broadcasting demodulator.

An embodiment of the invention discloses a digital broadcasting demodulator for an embedded multimedia system. The embedded multimedia system includes an antenna and an analog demodulator for playing analog audio broadcasting signals, the digital broadcasting demodulator includes a digital broadcasting transformation module which includes an input end and an output end, for receiving digital audio signals through the input end, transforming the received digital audio signals into analog audio signals, and outputting the analog audio signals via the output end, and a switch module includes a first end coupled to the antenna, a second end coupled to the analog demodulator, a third end coupled to the output end of the digital broadcasting transformation module, a fourth end coupled to the input end of the digital broadcasting transformation module, and a switch unit coupled to the first end, the second end, the third end, and the fourth end, for conducting a signal connection between the first end and the second end, or conducting signal connections between the first end and the fourth end and between the third end and the second end, according to an operating mode of the embedded multimedia system.

An embodiment of the invention further discloses an embedded multimedia system for playing analog and digital broadcasting audio signals, which includes an antenna for receiving analog and digital audio broadcasting signals, an audio output device for outputting sound, an analog demodulator for demodulating analog audio broadcasting signals for outputting sounds via the audio output device, and a digital demodulator coupled to the antenna and the analog demodulator for conducting a signal connection between the antenna and the analog demodulator, or transforming the digital audio broadcasting signals into analog audio broadcasting signals for the analog demodulator, according to an operating mode of the embed multimedia system.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an embedded multimedia system according to an embodiment of the invention.

FIG. 2 is a schematic diagram of the digital demodulator shown in FIG. 1 according to an embodiment of the invention.

FIG. 3 is a schematic diagram of the switch unit shown in FIG. 2 according to an embodiment of the invention.

### DETAILED DESCRIPTION

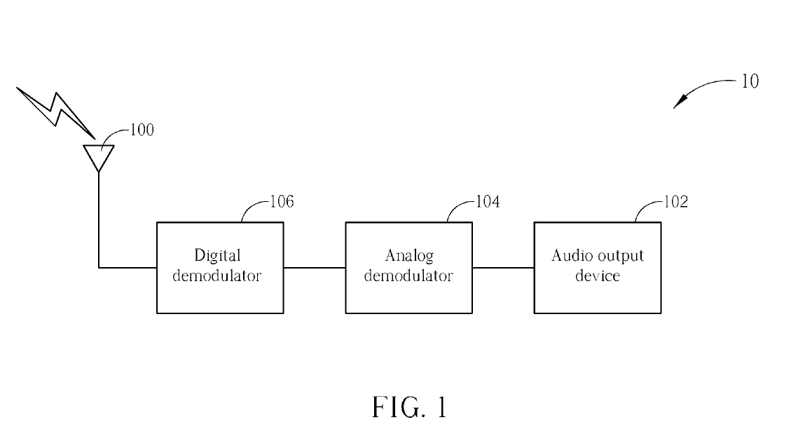

Please refer to FIG. 1. FIG. 1 is a schematic diagram of an embedded multimedia system 10 according to an embodiment of the invention. The embedded multimedia system 10 is preferably a vehicle multimedia system, and includes an antenna 100, an audio output device 102, an analog demodulator 104, and a digital demodulator 106. The antenna 100 is utilized for receiving analog and digital audio broadcasting signals. The digital demodulator 106 is coupled between the antenna 100 and the analog demodulator 104 for conducting a signal connection between the antenna 100 and the analog demodulator 104, or transforming digital audio broadcasting signals into analog audio broadcasting signals for the analog demodulator 104, according to an operating mode of the embedded multimedia system 10. The analog demodulator 104 is coupled to the digital demodulator 106, and utilized for demodulating analog audio broadcasting signals, so as to output sounds via the audio output device 102.

Therefore, using the embedded multimedia system 10, when a user wants to receive analog broadcasting programs, the digital demodulator 106 conducts the signal connection between the antenna 100 and the analog demodulator 104. When the user wants to receive digital broadcasting programs, the digital demodulator 106 transforms the digital audio broadcasting signals into analog audio broadcasting signals for the analog demodulator 104, in order to play the digital broadcasting programs via the audio output device 102.

As mentioned above, due to the vehicle multimedia system is integrated with a vehicle housing or interior, the user cannot easily replace broadcasting demodulator, so that the user cannot receive the digital broadcasting programs. In such a condition, according to the invention, the user can add the digital demodulator 106 between the antenna 100 and the analog demodulator 104 to receive analog and digital broadcasting programs.

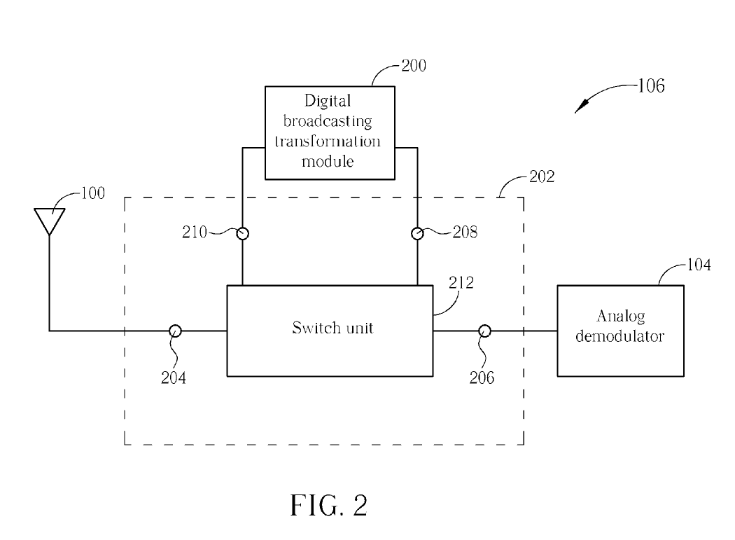

Note that, FIG. 1 is a schematic diagram according to an exemplary embodiment of the invention, and those skilled in the art can make alternations and modifications accordingly. For example, please refer to FIG. 2. FIG. 2 is a schematic diagram of the digital demodulator 106 shown in FIG. 1 according to an embodiment of the invention. The digital demodulator 106 includes a digital broadcasting transformation module 200 and a switch module 202. The digital broadcasting transformation module 200 is utilized for receiving digital audio broadcasting signals and transforming the received digital audio broadcasting signals into analog audio broadcasting signals. The switch module 202 includes a first end 204, a second end 206, a third end 208, a fourth end 210, and a switch unit 212. The first end 204 is coupled to the antenna 100. The second end 206 is coupled to the analog demodulator 104. The third end 208 is coupled to the output end of the digital broadcasting transformation module 200. The fourth end 210 is coupled to the input end of the digital broadcasting transformation module 200. The switch unit 212 is coupled to the first end 204, the second end 206, the third end 208, and the fourth end 210, and utilized for conducting a signal connection between the first end 204 and the second end 206, or conducting signal connections between the first end 204 and the fourth end 210 and between the third end 208 and the second end 206, according to the operating mode of the embedded multimedia system 10. For example, when the embedded multimedia system 10 operates in an analog broadcast mode, the switch unit 212 conducts the signal connection between the first end 204 and the second end 206. When the embedded multimedia system 10 operates in a digital broadcast mode, the switch unit 212 conducts the signal connections between the first end 204 and the fourth end 210 and between the third end 208 and the second end 206. Thus, the user can receive the analog and digital broadcasting programs.

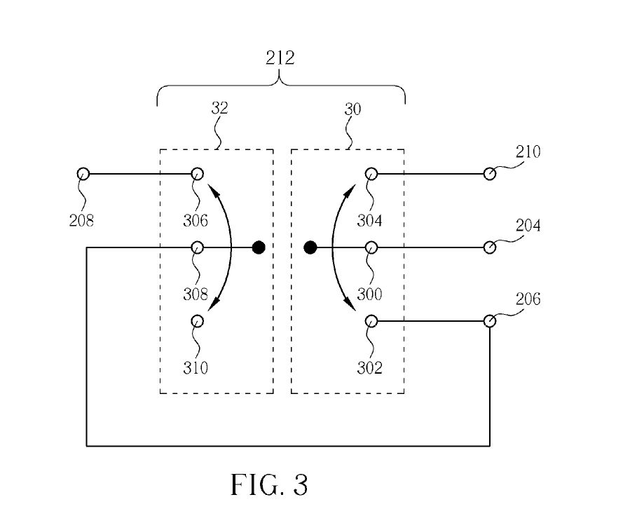

Please further refer to FIG. 3. FIG. 3 is a schematic diagram of the switch unit 212 shown in FIG. 2 according to an embodiment of the invention. The switch unit 212 includes a first switch 30 and a second switch 32. Both of the first switch 30 and the second switch 32 are three-terminal components, and include signal ends 300, 302, 304 and signal ends 306, 308, 310 respectively. The first switch 30 and the second switch 32 are synchronous switches, i.e. while the signal end 300 is connected to the signal end 304, the signal end 308 is also connected to the signal end 306. In other words, when the embedded multimedia system 10 operates in the analog broadcast mode, the signal end 300 is connected to the signal end 302, and the signal end 308 is connected to the floating signal end 310, in order to connect the first end 204 with the second end 206. When the embedded multimedia system 10 operates in a digital broadcast mode, the signal end 300 is connected to the signal end 304, and the signal end 308 is connected to the signal end 306 synchronously, in order to connect the first end 204 with the fourth end 210 and the third end 208 with the second end 206. Thus, the user can receive the analog and digital broadcasting programs.

Note that, FIG. 1 to FIG. 3 are used to illustrate the invention, but are not limitation of the invention, and those skilled in the art can make alternations and modifications accordingly.

In conclusion, targeting at the embedded multimedia system supporting only analog broadcasting function, such as vehicle multimedia systems, the invention performs only slight modification on the embedded multimedia system, and can expand the broadcasting function to play the analog and digital broadcasting programs without replace original components. Therefore, the invention not only reserves the original function of the vehicle multimedia system, but also preserves the integrity of the vehicle interior without substantial modification.

Those skilled in the art will readily observe that numerous modifications and alterations of the device and method may be made while retaining the teachings of the invention.

What is claimed is:

1. A digital broadcasting demodulator for an embedded multimedia system, the embedded multimedia system comprising an antenna and an analog demodulator for playing analog audio broadcasting signals, the digital broadcasting demodulator comprising:
a digital broadcasting transformation module comprising an input end and an output end, for receiving digital audio signals through the input end, transforming the received digital audio signals into analog audio signals, and outputting the analog audio signals via the output end; and
a switch module comprising:
a first end coupled to the antenna;
a second end coupled to the analog demodulator;
a third end coupled to the output end of the digital broadcasting transformation module;
a fourth end coupled to the input end of the digital broadcasting transformation module; and
a switch unit coupled to the first end, the second end, the third end, and the fourth end, for conducting a signal connection between the first end and the second end, or conducting signal connections between the first end and the fourth end and between the third end and the second end, according to an operating mode of the embedded multimedia system.

2. The digital broadcasting demodulator of claim 1, wherein when the embedded multimedia system operates in an analog broadcast mode, the switch unit conducts the signal connection between the first end and the second end.

3. The digital broadcasting demodulator of claim 1, wherein when the embedded multimedia system operates in a digital broadcast mode, the switch unit conducts the signal connections between the first end and the fourth end and between the third end and the second end.

4. The digital broadcasting demodulator of claim 1, wherein the switch unit comprises:
a first switch comprising a first signal end coupled to the first end, a second signal end coupled to the second end, and a third signal end coupled to the fourth end, for conducting a signal connection between the first signal end and the second signal end, or conducting a signal connection between the first signal end and the third signal end, according to the operating mode of the embedded multimedia system; and
a second switch comprising a fourth signal end coupled to the third end, a fifth signal end coupled to the second end, for conducting a signal connection between the fourth signal end and the fifth signal end according to the conduction of the first switch.

5. The digital broadcasting demodulator of claim 4, wherein when the signal connection between the first signal end and the third signal end of the first switch is conducted, the signal connection between the fourth signal end and the fifth signal end of the second switch is conducted.

6. The digital broadcasting demodulator of claim 1, wherein the embedded multimedia system is a vehicle multimedia system.

7. An embedded multimedia system for playing analog and digital audio broadcasting signals comprising:
an antenna for receiving analog and digital audio broadcasting signals;
an audio output device for outputting sound;
an analog demodulator for demodulating analog audio broadcasting signals for outputting sounds via the audio output device; and
a digital demodulator coupled to the antenna and the analog demodulator for conducting a signal connection between the antenna and the analog demodulator, or transforming digital audio broadcasting signals into analog audio broadcasting signals for the analog demodulator, according to an operating mode of the embed multimedia system.

8. The embedded multimedia system of claim 7, wherein the digital demodulator comprises:
a digital broadcasting transformation module comprising an input end and an output end, for receiving digital audio signals through the input end, transforming the received digital audio signals into analog audio signals, and outputting the analog audio signals via the output end; and
a switch module comprising:
a first end coupled to the antenna;
a second end coupled to the analog demodulator;
a third end coupled to the output end of the digital broadcasting transformation module;
a fourth end coupled to the input end of the digital broadcasting transformation module; and
a switch unit coupled to the first end, the second end, the third end, and the fourth end, for conducting a signal connection between the first end and the second end, or conducting signal connections between the first end and the fourth end and between the third end and the second end, according to an operating mode of the embedded multimedia system.

9. The embedded multimedia system of claim 8, wherein when the embedded multimedia system operates in an analog broadcast mode, the switch unit conducts the signal connection between the first end and the second end.

10. The embedded multimedia system of claim 8, wherein when the embedded multimedia system operates in a digital broadcast mode, the switch unit conducts the signal connections between the first end and the fourth end and between the third end and the second end.

11. The embedded multimedia system of claim 8, wherein the switch unit comprises:
a first switch comprising a first signal end coupled to the first end, a second signal end coupled to the second end, and a third signal end coupled to the fourth end, for conducting a signal connection between the first signal end and the second signal end, or conducting a signal connection between the first end signal and the third signal end, according to the operating mode of the embedded multimedia system; and
a second switch comprising a fourth signal end coupled to the third end, a fifth signal end coupled to the second end, for conducting a signal connection between the fourth signal end and the fifth signal end according to the conduction of the first switch.

12. The embedded multimedia system of claim 11, wherein when the signal connection between the first signal end and the third signal end of the first switch is conducted, the signal connection between the fourth signal end and the fifth signal end of the second switch is conducted.

13. The embedded multimedia system of claim 7, wherein the embedded multimedia system is a vehicle multimedia system.
